(19) United States
(12) Patent Application Publication
(10) Pub. No.: US 2026/0106482 A1
(43) Pub. Date: Apr. 16, 2026

(54) Battery backup control method and apparatus, server, and non-volatile readable storage medium

(71) Applicant: IEIT SYSTEMS CO., LTD., Jinan, Shandong (CN)

(72) Inventors: Yanjiao CHEN, Jinan, Shandong (CN); Yulong HUANG, Jinan, Shandong (CN); Qinglin LIU, Jinan, Shandong (CN)

(73) Assignee: IEIT SYSTEMS CO., LTD., Jinan, Shandong (CN)

(21) Appl. No.: 19/116,355

(22) PCT Filed: Dec. 26, 2023
(86) PCT No.: PCT/CN2023/141946

§ 371 Date: Mar. 27, 2025

(30) Foreign Application Priority Data
Mar. 14, 2023 (CN) 202310239169.1

(51) Int. Cl. H02J 9/06

(52) U.S. Cl. CPC H02J 9/06; H02J 7/80; H02J 7/933

(57) ABSTRACT

This application discloses a battery backup control method and apparatus, a server, and a non-volatile readable storage medium, and relates to the field of battery power supply. The method includes: acquiring a current backup state of a battery in a case of detecting that a power supply unit is in non-redundant power supply, where backup states include a cold backup state and a hot backup state; maintaining the hot backup state when the current backup state is the hot backup state; sending a discharge enable signal to the battery when the current backup state is the cold backup state; and controlling the current backup state of the battery to update to the hot backup state from the cold backup state according to the discharge enable signal. In the method, the battery is controlled to be in the hot backup power supply in the case of detecting that the power supply unit is in the non-redundant power supply, and since the hot backup power supply provides a discharge capability to the outside, after the power supply unit is disconnected, the battery may serve as a supply unit for data backup, thereby improving power supply stability and reliability of a storage system, and reducing the risk of data loss.

### CROSS-REFERENCE TO RELATED APPLICATION

The present claims priority to Chinese Patent Application No. 2023102391691, filed in the China National Intellectual Property Administration (CNIPA) on Mar. 14, 2023, and entitled “BATTERY BACKUP CONTROL METHOD AND APPARATUS, SERVER, AND MEDIUM”, which is incorporated herein by reference in its entirety.

### TECHNICAL FIELD

This application relates to the field of battery power supply, and in particular, to a battery backup control method and apparatus, a server, and a non-volatile readable storage medium.

### BACKGROUND

A storage device requires a battery as a supply unit for data backup after power outages, serving as the last line of defense to protect data from loss. The stability of power supply after a Power Supply Unit (PSU) is disconnected is of utmost importance. Backup modes of a Battery Backup Unit (BBU) include a hot backup power supply mode and a cold backup power supply mode. A mainstream backup mode is cold backup power supply using the battery backup unit. That is, after the power supply unit experiences abnormal power supply, hardware switches to power supply through the battery backup unit within a few milliseconds, with internal capacitors of the power supply unit maintaining power during this period. Power supply through the power supply unit is divided into redundant power supply and non-redundant power supply. The redundant power supply involves simultaneous power supply through two power supply units, and the non-redundant power supply involves power supply through a single power supply unit. Under the non-redundant power supply, when the power supply unit encounters a main circuit topology anomaly (damage to critical components) or a short circuit, internal capacitors will fail to work, causing the power supply unit to directly cease power supply. As a result, the storage device will shut down directly, leading to data loss.

Therefore, when the power supply unit is in a non-redundant state, how to ensure that the data may not get lost as much as possible is an urgent technical problem for those skilled in the art to solve.

An objective of this application is to provide a battery backup control method and apparatus, a server, and a non-volatile readable storage medium, which are configured to reduce the risk of data loss when a power supply unit is in a non-redundant state.

In order to solve the above technical problems, this application provides a battery backup control method, including:
acquiring a current backup state of a battery in a case of detecting that a power supply unit is in non-redundant power supply, where backup states include a cold backup state and a hot backup state;
maintaining the hot backup state when the current backup state is the hot backup state;
sending a discharge enable signal to the battery when the current backup state is the cold backup state; and controlling the current backup state of the battery to update to the hot backup state from the cold backup state according to the discharge enable signal.

Optionally, after detecting that the current backup state is the hot backup state or controlling the current backup state of the battery to update to the hot backup state from the cold backup state according to the discharge enable signal, the method further includes:
acquiring a current charge cut-off current threshold of the battery;
reducing the current charge cut-off current threshold to a target charge cut-off current threshold, where the target charge cut-off current threshold is less than the current charge cut-off current threshold; and
controlling charging or discharging of the battery according to the target charge cut-off current threshold.

Optionally, determining the target charge cut-off current threshold includes:
acquiring a voltage corresponding to twice a backup power capacity after a single charge of the battery; and
determining the target charge cut-off current threshold according to the voltage.

Optionally, after the controlling charging or discharging of the battery according to the target charge cut-off current threshold, the method further includes:
judging a full charge condition of the battery to determine a current operation state of the battery, wherein operation states includes an uncharged state, a charged state, a full charge state, and an idle state.

Optionally, the judging a full charge condition of the battery to determine a current operation state of the battery includes:
acquiring a current voltage value, a current value, and a full charge voltage threshold of the battery; and
judging the full charge condition of the battery to determine the current operation state of the battery according to the current voltage value, the current value, the target charge cut-off current threshold, and the full charge voltage threshold.

Optionally, the judging the full charge condition of the battery to determine the current operation state of the battery according to the current voltage value, the current value, the target charge cut-off current threshold, and the full charge voltage threshold includes:
acquiring a current value at a first preset moment when the current value is negative, where the first preset moment is a moment before a corresponding current moment when the current value is acquired;
judging whether the current voltage value is greater than the full charge voltage threshold when the current value at the first preset moment is positive and is less than the target charge cut-off current threshold;
determining the current operation state of the battery as the full charge state when the current voltage value is greater than the full charge voltage threshold;
determining the current operation state of the battery as the idle state when the current voltage value is not greater than the full charge voltage threshold; and
determining the current operation state of the battery as the uncharged state when the current value at the first preset moment does not meet the conditions of being positive and less than the target charge cut-off current threshold.

Optionally, after detecting that the current value is negative and before the acquiring a current value at a first preset moment, the method further includes:
judging whether the current backup state is the hot backup state;
proceeding to the operation of acquiring a current value at a first preset moment when the current backup state is the hot backup state; and
determining the current operation state of the battery as the uncharged state when the current backup state is not the hot backup state.

Optionally, after the acquiring a current voltage value, a current value, and a full charge voltage threshold of the battery, the method further includes:
judging whether the current value is equal to 0;
acquiring a current value at a second preset moment when the current value is not equal to 0, where the second preset moment is a moment before a corresponding current moment when the current value is acquired;
judging whether the current voltage value is greater than the full charge voltage threshold when the current value at the second preset moment is equal to 0; determining the current operation state of the battery as the full charge state when the current voltage value is greater than the full charge voltage threshold; and determining the current operation state of the battery as the idle state when the current voltage value is not greater than the full charge voltage threshold

Optionally, the full charge voltage threshold is determined according to chemical characteristics of the battery.

Optionally, after acquiring the current value of the battery, the method further includes:
judging whether the current value is positive; and
determining the current operation state of the battery as the charged state when the current backup state is positive.

Optionally, the method further includes:
controlling the current backup state of the battery to the cold backup state in a case of detecting that power supply units are in redundant power supply.

Optionally, before the judging whether the current value is equal to 0, the method further includes:
acquiring a charge current value of the battery at each moment within a first preset duration in a cold backup charge scenario;
controlling the battery to stop charging and proceeding to the operation of judging whether the current value is equal to 0 when the charge current value at each moment is less than the target charge cut-off current threshold; and proceeding to the operation of acquiring a current value at a second preset moment when the current value is equal to 0.

Optionally, after the controlling the battery to stop charging and before the judging whether the current value is equal to 0, the method further includes:
acquiring a current value at each moment within the second preset duration when controlling the battery to stop charging; and
proceeding to the operation of judging whether the current value is equal to 0 when the current value at each moment is equal to 0, and proceeding to the operation of acquiring a current value at a second preset moment when the current value is equal to 0.

Optionally, after detecting that the current backup state is the hot backup state, or controlling the current backup state of the battery to update to the hot backup state from the cold backup state according to the discharge enable signal, or controlling the current backup state of the battery to the cold backup state, the method further includes:
acquiring the current backup state of the battery according to a fixed frequency; and
controlling charging or discharging of the battery according to the current backup state.

Optionally, after the acquiring the current backup state of the battery according to a fixed frequency, the method further includes:
outputting information of the current backup state within a third preset duration when acquiring the current backup state of the battery.

Optionally, after the judging the full charge condition of the battery to determine the current operation state of the battery, the method further includes:
setting different prompt information according to the current operation state of the battery.

Optionally, the method includes:
monitoring an IO state of the power supply unit in real time; and
determining a redundant state of the power supply unit according to the IO state.

In order to solve the above technical problems, this application further provides a battery backup control apparatus, including:
an acquiring module, configured to acquire a current backup state of a battery in a case of detecting that a power supply unit is in non-redundant power supply, where backup states include a cold backup state and a hot backup state;
a maintenance module, configured to maintain the hot backup state when the current backup state is the hot backup state; and
an issue and control module, configured to issue a discharge enable signal to the battery when the current backup state is the cold backup state, and control the current backup state of the battery to update to the hot backup state from the cold backup state according to the discharge enable signal.

In order to solve the above technical problems, this application further provides a server, including:
a memory, configured to store a computer program; and
a processor, configured to implement, when executing the computer program, the operations of the above battery backup control method.

In order to solve the above technical problems, this application further provides a non-volatile readable storage medium, having a computer program stored therein. The computer program, when executed by a processor, implements the operations of the above battery backup control method.

The battery backup control method provided in this application includes: acquiring the current backup state of the battery in the case of detecting that the power supply unit is in the non-redundant power supply, where the backup states include the cold backup state and the hot backup state; maintaining the hot backup state when the current backup state is the hot backup state; sending the discharge enable signal to the battery when the current backup state is the cold backup state; and updating the current backup state of the battery to the hot backup state from the cold backup state according to the discharge enable signal. Compared to a previous method that the battery uses the cold backup power supply when the power supply unit is in the non-redundant power supply, consequently, after the power supply unit is disconnected, a storage device will directly shut down, leading to data loss, in the method provided in this application, the battery is controlled to be in the hot backup power supply in the case of detecting that the power supply unit is in the non-redundant power supply, and since the hot backup power supply provides a discharge capability to the outside, after the power supply unit is disconnected, the battery may serve as a supply unit for data backup, thereby improving power supply stability and reliability of a storage system, and reducing the risk of data loss.

Additionally, this application further provides a battery backup control apparatus, a device, and a non-volatile readable storage medium, which have the same or corresponding technical features as the aforementioned battery backup control method, and have the same effects as above.

### BRIEF DESCRIPTION OF THE DRAWINGS

To describe embodiments of this application more clearly, the following briefly introduces accompanying drawings required for describing the embodiments. Apparently, the accompanying drawings in the following description are merely some embodiments of this application, and those of ordinary skill in the art may also derive other accompanying drawings from these accompanying drawings without creative efforts.

FIG. 1 is a flowchart of a battery backup control method according to an embodiment of this application;

FIG. 2 is a flowchart of a charge processing method according to an embodiment of this application;

FIG. 3 is a structural diagram of a battery backup control apparatus according to an embodiment of this application;

FIG. 4 is a structural diagram of a server according to another embodiment of this application; and

FIG. 5 is a flowchart of a method for processing battery cold/hot backup switching according to an embodiment of this application.

### DETAILED DESCRIPTION OF THE EMBODIMENTS

The technical solutions in embodiments of this application are clearly and completely described below with reference to accompanying drawings in the embodiments of this application. Apparently, the described embodiments are merely some rather than all of the embodiments of this application. All other embodiments obtained by those of ordinary skill in the art based on the embodiments of this application without creative efforts shall fall within the scope of protection of this application.

The core of this application is to provide a battery backup control method and apparatus, a server, and a non-volatile readable storage medium, which are configured to reduce the risk of data loss when a power supply unit is in a non-redundant state.

Ensuring that data may not get lost in a storage device is of utmost importance. The storage device includes the power supply unit and a battery backup unit. The battery backup unit is typically a hardware battery pack. After the power supply unit is disconnected, a battery serves as a supply unit for data backup after power outages, which plays an important role in protecting data in the storage device.

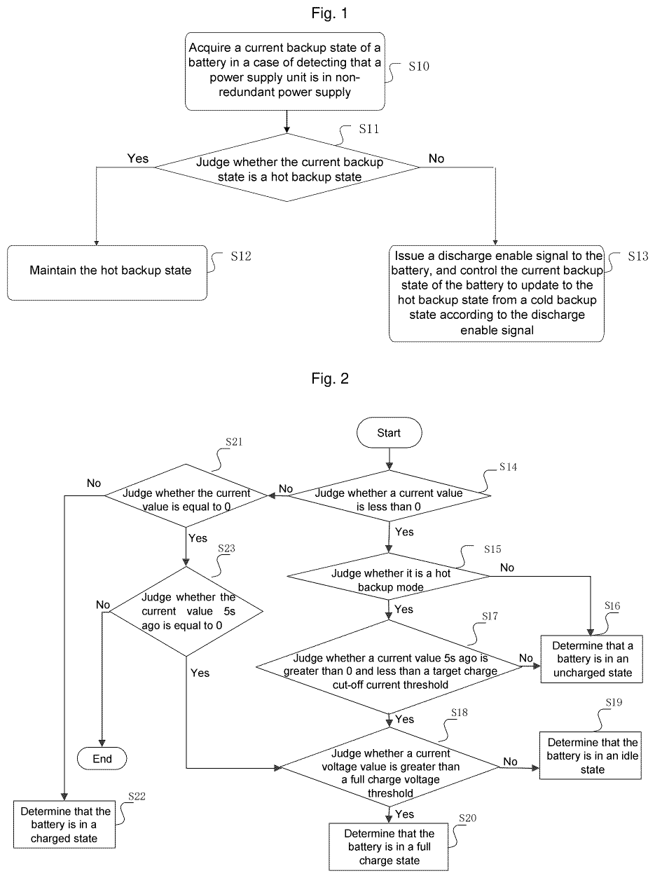

To facilitate a better understanding of the solutions of this application by those skilled in the art, this application is described below with reference to the accompanying drawings and optional implementations. FIG. 1 is a flowchart of a battery backup control method according to an embodiment of this application. As shown in FIG. 1, the method includes:
S10: Acquire a current backup state of a battery in a case of detecting that a power supply unit is in non-redundant power supply,
where backup states include a cold backup state and a hot backup state.
S11: Judge whether the current backup state is the hot backup state, proceed to operation S12 when the current backup state is the hot backup state, and proceed to operation S13 when the current backup state is not the hot backup state.
S12: Maintain the hot backup state.
S13: Issue a discharge enable signal to the battery, and control the current backup state of the battery to update to the hot backup state from the cold backup state according to the discharge enable signal.

Backup modes of a battery backup unit include cold backup power supply and hot backup power supply. In the cold backup power supply mode, when the power supply unit experiences abnormal power supply, hardware switches to power supply through the battery backup unit within a few milliseconds, with internal capacitors of the power supply unit maintaining power during this period. In the hot backup power supply mode, a discharge branch of the battery backup unit remains open, continuously providing a discharge capability to the outside to ensure a stable supply voltage.

When there are a plurality of power supply units, (i.e., redundant power supply units), the plurality of power supply units supply power simultaneously. When one power supply unit is disconnected or fails, internal capacitors of the normally functioning power supply units may still maintain power supply for a few milliseconds before switching to power supply through the battery backup unit. Therefore, the current backup state of the battery is controlled to the cold backup state in a case of detecting that the power supply units are in the redundant power supply. However, when there is only one power supply unit (i.e., a non-redundant power supply unit), after the power supply unit is disconnected or fails, an internal supply unit of the power supply unit will cease to function, causing the power supply unit to stop supplying power directly, resulting in the direct storage device shutdown and data loss. Therefore, according to the battery backup control method provided in this embodiment, the hot backup power supply is adopted when the power supply unit is in the non-redundant power supply, and the discharge capability is provided to the outside through the hot backup power supply. Accordingly, after the power supply unit is disconnected, the battery may serve as a supply unit for data backup, thereby improving power supply stability and reliability of a storage system, and reducing the risk of data loss.

In this embodiment, an Input/Output (IO) state of the power supply unit is monitored through a Complex Programmable Logic Device (CPLD), and a redundant state of the power supply unit is determined according to the IO state. A frequency at which the CPLD monitors the IO state of the power supply unit is not limited. To know the IO state of the power supply unit in real time, according to an optional implementation, the IO state of the power supply unit is monitored in real time through the CPLD, and the redundant state of the power supply unit is determined according to the real-time monitored IO state.

When the cold backup power supply is adopted, when the power supply unit is not redundant, and encounters a main circuit topology anomaly (damage to critical components) or a short circuit, internal capacitors will fail to work, causing the power supply unit to directly cease power supply. As a result, a storage device will shut down abruptly, leading to data loss. Therefore, in this embodiment, in a case of detecting that the power supply unit is in the non-redundant power supply, it is ensured that the backup mode of the battery is the hot backup power supply.

Optionally, the current backup state of the battery is first acquired, and when the current backup state is the cold backup state, the discharge enable signal needs to be sent to the battery. After the battery receives the discharge enable signal, the discharge branch is opened, continuously providing the discharge capability to the outside to implement the update of the current backup state to the hot backup state from the cold backup state. When the current backup state is the hot backup state, there is no need to adjust the backup mode, and the hot backup state is maintained.

The battery backup control method provided in this embodiment includes: acquiring the current backup state of the battery in the case of detecting that the power supply unit is in the non-redundant power supply, where the backup states include the cold backup state and the hot backup state; maintaining the hot backup state when the current backup state is the hot backup state; sending the discharge enable signal to the battery when the current backup state is the cold backup state; and controlling the current backup state of the battery to update to the hot backup state from the cold backup state according to the discharge enable signal. Compared to a previous method that the battery uses the cold backup power supply when the power supply unit is in the non-redundant power supply, consequently, after the power supply unit is disconnected, the storage device will directly shut down, leading to data loss, in the method provided in this embodiment, the battery is controlled to be in the hot backup power supply in the case of detecting that the power supply unit is in the non-redundant power supply, and since the hot backup power supply provides the discharge capability to the outside, after the power supply unit is disconnected, the battery may serve as the supply unit for data backup, thereby improving the power supply stability and reliability of the storage system, and reducing the risk of data loss.

When the current backup state of a power supply is the hot backup state or is updated to the hot backup state, the battery hot backup requires voltage reduction output through a BUCK circuit, and there will be losses in a Metal Oxide Semiconductor Field Effect Transistor (MOSFET, abbreviated as MOS) switch within the BUCK circuit, leading to a problem of leakage current. Persistent leakage current may affect the service life of the battery. Therefore, in this embodiment, according to the optional implementation, after detecting that the current backup state is the hot backup state or controlling the current backup state of the battery to update to the hot backup state from the cold backup state according to the discharge enable signal, the battery backup control method further includes:
acquiring a current charge cut-off current threshold of the battery;
reducing the current charge cut-off current threshold to a target charge cut-off current threshold, where the target charge cut-off current threshold is less than the current charge cut-off current threshold; and
controlling charging or discharging of the battery according to the target charge cut-off current threshold.

Determining the target charge cut-off current threshold includes:
acquiring a voltage corresponding to twice a backup power capacity after a single charge of the battery; and
determining the target charge cut-off current threshold according to the voltage.

It should be noted that the charge cut-off current threshold herein refers to a minimum charge threshold. The minimum charge threshold is determined according to a discharge capability of the battery. When the battery is in the hot backup state, due to the leakage current, battery charging may be frequently triggered, affecting the service life of the battery. Therefore, the current charge cut-off current threshold is reduced to the target charge cut-off current threshold.

According to the method provided in this embodiment, by reducing the target charge cut-off current threshold and a charge-discharge switching frequency, the service life of the battery is prolonged.

After controlling the charging or discharging of the battery according to the target charge cut-off current threshold, to accurately acquire an operation state of the battery, according to an optional implementation, the battery backup control method further includes:
judging a full charge condition of the battery to determine a current operation state of the battery, where operation states include an uncharged state, a charged state, a full charge state, and an idle state.

Optionally, the judging a full charge condition of the battery to determine a current operation state of the battery includes:
acquiring a current voltage value, a current value, and a full charge voltage threshold of the battery; and
judging the full charge condition of the battery to determine the current operation state of the battery according to the current voltage value, the current value, the target charge cut-off current threshold, and the full charge voltage threshold.

In an embodiment, the judging the full charge condition of the battery to determine the current operation state of the battery according to the current voltage value, the current value, the target charge cut-off current threshold, and the full charge voltage threshold includes:
acquiring a current value at a first preset moment when the current value is negative, where the first preset moment is a moment before a corresponding current moment when the current value is acquired;
judging whether the current voltage value is greater than the full charge voltage threshold when the current value at the first preset moment is positive and is less than the target charge cut-off current threshold;
determining the current operation state of the battery as the full charge state when the current voltage value is greater than the full charge voltage threshold;
determining the current operation state of the battery as the idle state when the current voltage value is not greater than the full charge voltage threshold; and
determining the current operation state of the battery as the uncharged state when the current value at the first preset moment does not meet the conditions of being positive and less than the target charge cut-off current threshold.

The first preset moment is not limited. For example, the first preset moment is a moment 5 s before the current moment, and after the current value is negative, whether the current value 5 s ago is positive and is less than the target charge cut-off current threshold is judged. When the current value 5 s ago is positive and is less than the target charge cut-off current threshold, whether the current voltage value is greater than the full charge voltage threshold is judged. The full charge voltage threshold is not limited. In this embodiment, to make the set full charge voltage threshold reasonable, optionally, the full charge voltage threshold is determined according to chemical characteristics of the battery. When the current voltage value is greater than the full charge voltage threshold, it may be determined that the current operation state of the battery is the full charge state, namely a full_charged state. When the current voltage value is not greater than the full charge voltage threshold, it is determined that the current operation state of the battery is the idle state. When the current value 5 s ago does not meet the conditions of being positive and less than the target charge cut-off current threshold, it is determined that the current operation state of the battery is the uncharged state, namely a discharging state.

It should be noted that after judging that the current value is negative, there may be a case where the battery automatically discharges, resulting in the negative current value. Therefore, according to an optional implementation, after detecting that the current value is negative, before the acquiring a current value at a first preset moment, the battery backup control method further includes:
judging whether the current backup state is the hot backup state;
proceeding to the operation of acquiring a current value at a first preset moment when the current backup state is the hot backup state; and
determining the current operation state of the battery as the uncharged state when the current backup state is not the hot backup state.

According to the processing method provided in this embodiment, after charging is ended, in the full charge state in a hot backup scenario, actual influences from the leakage current in the hot backup state are fully considered, thereby achieving precise management in the charge and discharge process.

In an embodiment, after the acquiring a current voltage value, a current value, and a full charge voltage threshold of the battery, the battery battery backup control method further includes:
judging whether the current value is equal to 0;
acquiring a current value at a second preset moment when the current value is not equal to 0, where the second preset moment is a moment before a corresponding current moment when the current value is acquired;
judging whether the current voltage value is greater than the full charge voltage threshold when the current value at the second preset moment is equal to 0; determining the current operation state of the battery as the full charge state when the current voltage value is greater than the full charge voltage threshold; and determining the current operation state of the battery as the idle state when the current voltage value is not greater than the full charge voltage threshold

In the hot backup state, the current value is necessarily negative. Therefore, when the current value is equal to 0, it indicates that the battery is not in the hot backup state but has stopped charging. The full charge state of the battery is judged after the current value at the second preset moment is equal to 0. The second preset moment is not limited, which may be the same with or different from the above first preset moment. Herein, whether the current value at the second preset moment is equal to 0 is judged. In practice, the full charge state of the battery may be judged after the current value within a period of time before the current moment is constantly 0. For example, when the second preset moment is 5 s before the current moment, and the current value 5 s ago is equal to 0 (or the current value has been 0 for the last 5 s continuously before the current moment), whether the current voltage value is greater than the full charge voltage threshold is judged. When the current voltage value is greater than the full charge voltage threshold, the current operation state of the battery is determined as the full_charged state. When the current voltage value is not greater than the full charge voltage threshold, the current operation state of the battery is determined as the idle state.

In addition to the operation states of the battery described above, in this embodiment, after acquiring the current value of the battery, the battery backup control method further includes:
judging whether the current value is positive; and
determining the current operation state of the battery as the charged state when the current backup state is positive.

In this embodiment, before the judging whether the current value is equal to 0, the battery backup control method further includes:
acquiring a charge current value of the battery at each moment within a first preset duration in a cold backup charge scenario;
controlling the battery to stop charging and proceeding to the operation of judging whether the current value is equal to 0 when the charge current value at each moment is less than the target charge cut-off current threshold; and proceeding to the operation of acquiring a current value at a second preset moment when the current value is equal to 0.

After controlling the battery to stop charging and before judging whether the current value is equal to 0, the battery backup control method further includes:
acquiring a current value at each moment within the second preset duration when controlling the battery to stop charging; and
proceeding to the operation of judging whether the current value is equal to 0 when the current value at each moment is equal to 0, and proceeding to the operation of acquiring a current value at a second preset moment when the current value is equal to 0.

The first preset duration and the second preset duration are not limited, which are determined according to actual conditions. For example, when the first preset duration is 20 s and the second preset duration is 10 s, in the cold backup charge scenario, when a battery charging current value is lower than the target charge cut-off current threshold for consecutive 20 s, charging is stopped. After the current value remains 0 for consecutive 10 s, the full charge state of the battery is judged, and operation state information of the battery is updated.

According to the processing method provided in this embodiment for the full charge state in a cold backup scenario after charging is ended, precise management in the charge and discharge process is achieved.

To facilitate understanding of the process for processing the full charge state in different cold and hot backup scenarios after charging is ended, the charge processing process is described again below with reference to FIG. 2. FIG. 2 is a flowchart of a charge processing method according to an embodiment of this application. As shown in FIG. 2, the method includes:
S14: Judge whether a current value is less than 0, proceed to operation S15 when the current value is less than 0, and proceed to operation S21 when the current value is not less than 0.
S15: Judge whether it is a hot backup mode, proceed to operation S16 in the hot backup mode, and proceed to operation S17 when it is not the hot backup mode.
S16: Determine that a battery is in an uncharged state.
S17: Judge whether a current value 5 s ago is greater than 0 and less than a target charge cut-off current threshold, return to operation S16 when judging that the current value 5 s ago is greater than 0 and less than the target charge cut-off current threshold, and proceed to operation S18 when not judging that the current value 5 s ago is greater than 0 and less than the target charge cut-off current threshold.
S18: Judge whether a current voltage value is greater than a full charge voltage threshold, proceed to operation S19 when judging that the current voltage value is greater than the full charge voltage threshold, and proceed to operation S20 when not judging that the current voltage value is greater than the full charge voltage threshold.
S19: Determine that the battery is in an idle state.
S20: Determine that the battery is in a full charge state.
S21: Judge whether the current value is equal to 0, proceed to operation S22 when the current value is not equal to 0, and proceed to operation S23 when the current value is equal to 0.
S22: Determine that the battery is in a charged state.
S23: Judge whether the current value 5 s ago is equal to 0, return to operation S18 when the current value 5 s ago is equal to 0, and end the process when the current value 5 s ago is not equal to 0.

The entire flowchart mainly includes the following four processes:
1. A charge and discharge module periodically acquires the current voltage value and the current value of the battery.
2. When the current value is less than 0, whether it is the hot backup mode is judged, and the charge state is updated to the discharging state when it is not the hot backup mode; and in the hot backup mode, whether the current value 5 s ago is greater than 0 and less than the charge cut-off current is continuously judged, and the judgment is used to limit the scenario as the scenario of leakage current after full charge is stopped. The charge state is updated to the discharging state when it is not judged that the current value 5 s ago is greater than 0 and less than the charge cut-off current; and when it is judged that the current value 5 s ago is greater than 0 and less than the charge cut-off current, whether the current voltage value is greater than a minimum full charge voltage is judged, when yes, the charge state is updated to the full_charged state, and when not, the charge state is updated to the idle state.
3. The current value being equal to 0 indicates that it is not the hot backup mode currently, but charging has been stopped, and after the current value 5 s ago is 0, the full charge state is judged.
4. When the current value is greater than 0, the charge state is updated to the charging state.

According to the method provided in this embodiment, the processing method is provided for the full charge state in different cold and hot backup scenarios after charging is ended, and therefore precise management in the charge and discharge process is achieved.

In this embodiment, to achieve charge and discharge control on the battery, according to an optional implementation, after detecting that the current backup state is the hot backup state, or controlling the current backup state of the battery to update to the hot backup state from the cold backup state according to the discharge enable signal, or controlling the current backup state of the battery to the cold backup state, the battery backup control method further includes:
acquiring the current backup state of the battery according to a fixed frequency; and
controlling charging or discharging of the battery according to the current backup state.

The fixed frequency is not limited. For example, the cold/hot backup state of the battery is acquired from the CPLD every 5 s, thereby managing charge and discharge of the battery according to the cold/hot backup state of the battery.

Based on the above embodiments, to facilitate the user to understand the current backup state of the battery, according to an optional implementation, after the acquiring the current backup state of the battery according to a fixed frequency, the battery backup control method further includes:
outputting information of the current backup state within a third preset duration when acquiring the current backup state of the battery.

The third preset duration is not limited, which is determined according to actual conditions. Through the method for outputting the information of the battery backup state according to this embodiment, the user is facilitated to understand the battery backup state.

In this embodiment, to facilitate the user to understand the operation state of the battery, according to an optional implementation, after the judging the full charge condition of the battery to determine the current operation state of the battery, the battery backup control method further includes:
setting different prompt information according to the current operation state of the battery.

The prompt information set according to the different operation states of the battery is not limited, as long as the prompt information under the different operation states is different. For example, when the battery is in the full charge state, an indicator light is controlled to display red as a prompt; in the charged state, the indicator light is controlled to display green as a prompt; in the uncharged state, the indicator light is controlled to display yellow as a prompt; and in the idle state, the indicator light is controlled to display white as a prompt.

According to this embodiment, the different prompt information is set according to the current operation state of the battery, thereby facilitating the user to intuitively understand the current operation state of the battery according to the prompt information.

According to the above embodiment, the battery backup control method is described in detail. This application further provides embodiments corresponding to a battery backup control apparatus and a server. It should be noted that the embodiments of the apparatus part are described from two perspectives: one based on functional modules and the other based on hardware.

FIG. 3 is a structural diagram of a battery backup control apparatus according to an embodiment of this application. This embodiment, based on the perspective of the functional modules, includes:
an acquiring module 10, configured to acquire a current backup state of a battery in a case of detecting that a power supply unit is in non-redundant power supply, where backup states include a cold backup state and a hot backup state;
a maintenance module 11, configured to maintain the hot backup state when the current backup state is the hot backup state; and
an issue and control module 12, configured to issue a discharge enable signal to the battery when the current backup state is the cold backup state, and control the current backup state of the battery to update to the hot backup state from the cold backup state according to the discharge enable signal.

Since the embodiments of the apparatus part correspond to those of the method part, please refer to the description of the embodiments of the method part on the embodiments of the apparatus part, which will not be repeated herein.

According to the battery backup control apparatus provided in this embodiment, the acquiring module acquires the current backup state of the battery in the case of detecting that the power supply unit is in the non-redundant power supply, where the backup states include the cold backup state and the hot backup state; the maintenance module maintains the hot backup state when the current backup state is the hot backup state; and when the current backup state is the cold backup state, the issue and control module issues the discharge enable signal to the battery and controls the current backup state of the battery to update to the hot backup state from the cold backup state according to the discharge enable signal. Compared to a previous method that the battery uses the cold backup power supply when the power supply unit is in the non-redundant power supply, consequently, after the power supply unit is disconnected, a storage device will directly shut down, leading to data loss, in the apparatus provided in this embodiment, the battery is controlled to be in the hot backup power supply in the case of detecting that the power supply unit is in the non-redundant power supply, and since the hot backup power supply provides a discharge capability to the outside, after the power supply unit is disconnected, the battery may serve as a supply unit for data backup, thereby improving power supply stability and reliability of a storage system, and reducing the risk of data loss.

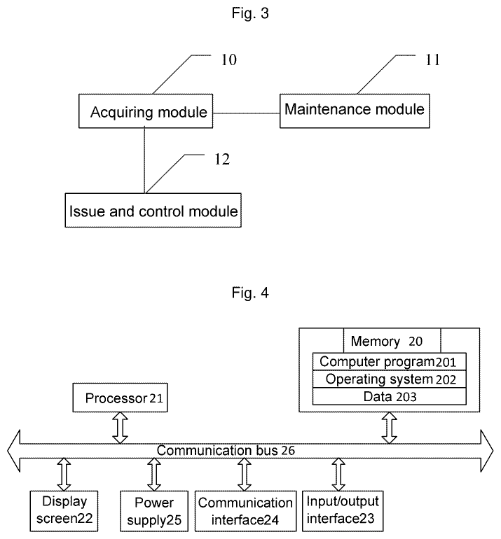

FIG. 4 is a structural diagram of a server according to another embodiment of this application. In this embodiment, based on the hardware perspective, as shown in FIG. 4, the server includes:
a memory 20, configured to store a computer program; and
a processor 21, configured to implement, when executing the computer program, the operations of the battery backup control method mentioned in the above embodiments.

The server provided in this embodiment may include, but is not limited to, a smartphone, a tablet, a laptop, a desktop computer, or the like.

The processor 21 may include one or more processing cores, such as a 4-core processor and an 8-core processor. The processor 21 may be implemented in at least one hardware form among a Digital Signal Processor (DSP), a Field-Programmable Gate Array (FPGA), and a Programmable Logic Array (PLA). The processor 21 may also include a main processor and a coprocessor. The main processor is a processor configured to process data in an awake state and is also known as a Central Processing Unit (CPU). The coprocessor is a low-power-consumption processor configured to process data in a standby state. In some embodiments, the processor 21 may be integrated with a Graphics Processing Unit (GPU). The GPU is configured to render and draw content required to be displayed on a display screen. In some embodiments, the processor 21 may also include an Artificial Intelligence (AI) processor configured to process computational operations related to machine learning.

The memory 20 may include one or more non-volatile readable storage media, which may be non-transient. The memory 20 may further include a high-speed random access memory and a non-volatile memory, such as one or more disk storage devices or flash storage devices. In this embodiment, the memory 20 is at least configured to store a following computer program 201. After being loaded and executed by the processor 21, the computer program may implement the relevant operations of the battery backup control method disclosed in any one of the aforementioned embodiments. Additionally, resources stored in the memory 20 may also include an operating system 202, data 203, etc., and a storage method may be temporary storage or permanent storage. The operating system 202 may include Windows, Unix, Linux, etc. The data 203 may include, but is not limited to, data related to the battery backup control method mentioned above.

In some embodiments, the server may also include a display screen 22, an input/output interface 23, a communication interface 24, a power supply 25, and a communication bus 26.

Those skilled in the art should understand that the structure shown in FIG. 4 does not constitute a limitation on the server and may include more or fewer components than illustrated.

The server provided in this embodiment of this application includes the memory and the processor. The processor, when executing the program stored in the memory, may implement the following method: the battery backup control method, with the same effects as described above.

This application further provides an embodiment corresponding to a non-volatile readable storage medium. The non-volatile readable storage medium has a computer program stored therein. The computer program, when executed by a processor, implements the operations recorded in the above method embodiments.

It should be understood that when the methods in the above embodiments are implemented in the form of a software functional unit and sold or used as independent products, the methods may be stored in a computer-readable storage medium. Based on the understanding, the technical solutions of this application essentially, or the part contributing to the related art, or all or some of the technical solutions may be embodied in the form of a software product. The computer software product is stored in a storage medium to perform all or some of the operations of the method according to various embodiments of this application. The aforementioned storage medium includes various media that may store program code, such as a U disk, a mobile hard disk, a Read-Only Memory (ROM), a Random Access Memory (RAM), a magnetic disk, or an optical disk.

The non-volatile readable storage medium provided by this application includes the aforementioned battery backup control method, with the same effects as described above.

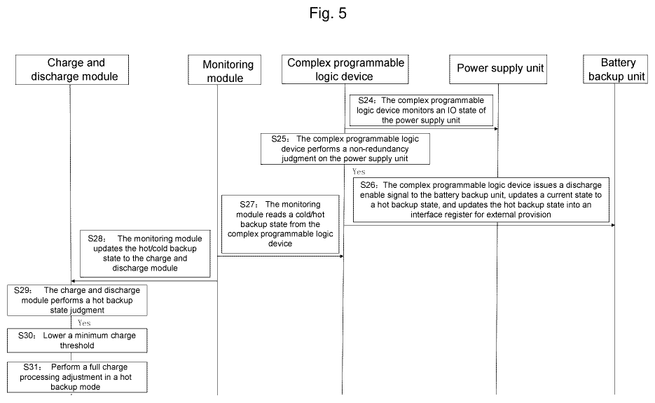

To facilitate a better understanding of the solutions of this application by those skilled in the art, this application is described in detail below with reference to FIG. 5 and optional implementations. FIG. 5 is a flowchart of a method for processing battery cold/hot backup switching according to an embodiment of this application. As shown in FIG. 5, the method includes:
S24: A complex programmable logic device monitors an IO state of a power supply unit.
S25: The complex programmable logic device performs a non-redundancy judgment on the power supply unit, and when it is judged that the power supply unit is non-redundant, proceed to operation S26.
S26: The complex programmable logic device issues a discharge enable signal to a battery backup unit, updates a current state to a hot backup state, and updates the hot backup state into an interface register for external provision.
S27: A monitoring module reads a cold/hot backup state from the complex programmable logic device.
S28: The monitoring module updates the hot/cold backup state to a charge and discharge module.
S29: The charge and discharge module performs a hot backup state judgment, and in a case of the hot backup state, proceed to operation S30.
S30: Lower a minimum charge threshold.
S31: Perform a full charge processing adjustment in a hot backup mode.

The power supply unit, as a supply unit, focuses on a redundant state; a battery module, as a hardware battery pack, focuses on a discharge enable state; the complex programmable logic device, as a hardware monitoring module, monitors a redundant state of a power supply module and controls discharge enable of the battery backup unit; and the monitoring module, as a storage server system, periodically acquires the hot/cold backup state of the battery backup unit obtained by the complex programmable logic device, and hands the hot/cold backup state over to a charge and discharge control module for managing the charge and discharge of the battery backup unit. In the charge and discharge process, a detailed process judgment and state transitions are performed according to the cold/hot backup state.

In the entire process, the complex programmable logic device monitors the IO state of the power supply unit in real time. When the power supply unit is non-redundant, the discharge enable signal is issued to the battery backup unit, and the current state is updated to the hot backup state and is updated into the interface register for the external provision. The monitoring module may acquire the hot/cold backup state from the complex programmable logic device every 5 s and update the hot/cold backup state to the charge and discharge module. When detecting that the current mode is the hot backup mode, the charge and discharge module lowers the minimum charge threshold, and performs a full charge judgment and a state update in the hot backup mode. The full charge processing process in the hot backup mode has been described in detail in FIG. 2, which will not be repeated herein.

In the method provided in this embodiment, according to the redundant state of the power supply unit, the complex programmable logic device is used to switch the cold-hot backup power supply mode of the battery backup unit, thereby improving the power supply stability and reliability of the storage system, and reducing the risk of data loss. Actual influences from the leakage current in the hot backup are fully considered, precise management in the charge and discharge process is achieved, the minimum charge threshold is dynamically adjusted, the charge and discharge switching frequency is reduced, and the service life of the battery backup unit is prolonged.

The above provides a detailed introduction to the battery backup control method and apparatus, the server, and the non-volatile readable storage medium provided in this application. The various embodiments in the specification are described in a progressive manner, with each embodiment highlighting the differences from other embodiments. The identical or similar parts between different embodiments may be cross-referenced to each other. The apparatus disclosed by the embodiment corresponds to the method disclosed by the embodiment, and therefore, the description is simple, and for associated parts, please refer to part of the description of the method. It should be noted that those of ordinary skill in the art may also make a plurality of improvements and modifications on this application without departing from the principle of this application, and these improvements and modifications shall fall within the scope of protection of the claims of this application.

It should also be noted that in the specification, relational terms such as first and second are only used to distinguish one entity or operation from another entity or operation, and do not necessarily require or imply that such an actual relationship or order exists between these entities or operations. Moreover, the terms “include”, “contain”, or any other variants thereof are intended to cover a non-exclusive inclusion, such that a process, a method, an article, or a device that includes a series of elements not only includes those elements but also includes other elements that are not expressly listed, or further includes elements inherent to such process, method, article, or device. In the absence of more restrictions, an element defined by the phrase “including a . . . ” does not exclude an additional identical element in the process, the method, the article, or the device that includes the element.

1. A battery backup control method, comprising:
acquiring a current backup state of a battery in a case of detecting that a power supply unit is in non-redundant power supply, wherein backup states comprise a cold backup state and a hot backup state;
maintaining the hot backup state when the current backup state is the hot backup state;
sending a discharge enable signal to the battery when the current backup state is the cold backup state; and controlling the current backup state of the battery to update to the hot backup state from the cold backup state according to the discharge enable signal.

2. The battery backup control method according to claim 1, wherein after detecting that the current backup state is the hot backup state or controlling the current backup state of the battery to update to the hot backup state from the cold backup state according to the discharge enable signal, the method further comprises:
acquiring a current charge cut-off current threshold of the battery;
reducing the current charge cut-off current threshold to a target charge cut-off current threshold, wherein the target charge cut-off current threshold is less than the current charge cut-off current threshold; and
controlling charging or discharging of the battery according to the target charge cut-off current threshold.

3. The battery backup control method according to claim 2, wherein determining the target charge cut-off current threshold comprises:
acquiring a voltage corresponding to twice a backup power capacity after a single charge of the battery; and
determining the target charge cut-off current threshold according to the voltage.

4. The battery backup control method according to claim 3, wherein after the controlling charging or discharging of the battery according to the target charge cut-off current threshold, the method further comprises:
judging a full charge condition of the battery to determine a current operation state of the battery, wherein operation states comprise an uncharged state, a charged state, a full charge state, and an idle state.

5. The battery backup control method according to claim 4, wherein the judging a full charge condition of the battery to determine a current operation state of the battery comprises:
acquiring a current voltage value, a current value, and a full charge voltage threshold of the battery; and
judging the full charge condition of the battery to determine the current operation state of the battery according to the current voltage value, the current value, the target charge cut-off current threshold, and the full charge voltage threshold.

6. The battery backup control method according to claim 5, wherein the judging the full charge condition of the battery to determine the current operation state of the battery according to the current voltage value, the current value, the target charge cut-off current threshold, and the full charge voltage threshold comprises:
acquiring a current value at a first preset moment when the current value is negative, wherein the first preset moment is a moment before a corresponding current moment when the current value is acquired;
judging whether the current voltage value is greater than the full charge voltage threshold when the current value at the first preset moment is positive and is less than the target charge cut-off current threshold;
determining the current operation state of the battery as the full charge state when the current voltage value is greater than the full charge voltage threshold;
determining the current operation state of the battery as the idle state when the current voltage value is not greater than the full charge voltage threshold; and
determining the current operation state of the battery as the uncharged state when the current value at the first preset moment does not meet the conditions of being positive and less than the target charge cut-off current threshold.

7. The battery backup control method according to claim 6, wherein after detecting that the current value is negative and before the acquiring a current value at a first preset moment, the method further comprises:
judging whether the current backup state is the hot backup state;
proceeding to the operation of acquiring a current value at a first preset moment when the current backup state is the hot backup state; and
determining the current operation state of the battery as the uncharged state when the current backup state is not the hot backup state.

8. The battery backup control method according to claim 5, wherein after the acquiring a current voltage value, a current value, and a full charge voltage threshold of the battery, the method further comprises:
judging whether the current value is equal to 0;
acquiring a current value at a second preset moment when the current value is not equal to 0, wherein the second preset moment is a moment before a corresponding current moment when the current value is acquired;
judging whether the current voltage value is greater than the full charge voltage threshold when the current value at the second preset moment is equal to 0; determining the current operation state of the battery as the full charge state when the current voltage value is greater than the full charge voltage threshold; and determining the current operation state of the battery as the idle state when the current voltage value is not greater than the full charge voltage threshold.

9. The battery backup control method according to claim 5, wherein the full charge voltage threshold is determined according to chemical characteristics of the battery.

10. The battery backup control method according to claim 5, wherein after acquiring the current value of the battery, the method further comprises:
judging whether the current value is positive; and
determining the current operation state of the battery as the charged state when the current backup state is positive.

11. The battery backup control method according to claim 1, further comprising:
controlling a current backup state of the battery to a cold backup state in a case of detecting that power supply units are in redundant power supply.

12. The battery backup control method according to claim 8, wherein before the judging whether the current value is equal to 0, the method further comprises:
acquiring a charge current value of the battery at each moment within a first preset duration in a cold backup charge scenario;
controlling the battery to stop charging and proceeding to the operation of judging whether the current value is equal to 0 when the charge current value at each moment is less than the target charge cut-off current threshold; and proceeding to the operation of acquiring a current value at a second preset moment when the current value is equal to 0.

13. The battery backup control method according to claim 12, wherein after the controlling the battery to stop charging and before the judging whether the current value is equal to 0, the method further comprises:
acquiring a current value at each moment within a second preset duration when controlling the battery to stop charging; and
proceeding to the operation of judging whether the current value is equal to 0 when the current value at each moment is equal to 0, and proceeding to the operation of acquiring a current value at a second preset moment when the current value is equal to 0.

14. The battery backup control method according to claim 11, wherein after detecting that the current backup state is the hot backup state, or controlling the current backup state of the battery to update to the hot backup state from the cold backup state according to the discharge enable signal, or controlling the current backup state of the battery to the cold backup state, the method further comprises:
acquiring the current backup state of the battery according to a fixed frequency; and
controlling charging or discharging of the battery according to the current backup state.

15. The battery backup control method according to claim 14, wherein after the acquiring the current backup state of the battery according to a fixed frequency, the method further comprises:
outputting information of the current backup state within a third preset duration when acquiring the current backup state of the battery.

16. The battery backup control method according to claim 4, wherein after the judging a full charge condition of the battery to determine a current operation state of the battery, the method further comprises:
setting different prompt information according to the current operation state of the battery.

17. The battery backup control method according to claim 1, further comprising:
monitoring an Input/Output (IO) state of the power supply unit in real time; and
determining a redundant state of the power supply unit according to the IO state.

18. (canceled)

19. A server, comprising:
a memory, configured to store a computer program; and
a processor, configured to implement, when executing the computer program, implements operations comprising:
acquiring a current backup state of a battery in a case of detecting that a power supply unit is in non-redundant power supply, wherein backup states comprise a cold backup state and a hot backup state;
maintaining the hot backup state when the current backup state is the hot backup state;
sending a discharge enable signal to the battery when the current backup state is the cold backup state; and controlling the current backup state of the battery to update to the hot backup state from the cold backup state according to the discharge enable signal.

20. A non-volatile readable storage medium, having a computer program stored therein, wherein the computer program, when executed by a processor, implements operations comprising:
acquiring a current backup state of a battery in a case of detecting that a power supply unit is in non-redundant power supply, wherein backup states comprise a cold backup state and a hot backup state;
maintaining the hot backup state when the current backup state is the hot backup state;
sending a discharge enable signal to the battery when the current backup state is the cold backup state; and controlling the current backup state of the battery to update to the hot backup state from the cold backup state according to the discharge enable signal.

21. The battery backup control method according to claim 17, wherein monitoring the IO state of the power supply unit in real time comprises:
monitoring the IO state of the power supply unit through a Complex Programmable Logic Device (CPLD).
